(19) United States
(12) Patent Application Publication
(10) Pub. No.: US 2013/0175257 A1
(43) Pub. Date: Jul. 11, 2013

(54) PLANE HEATING ELEMENT USING CERAMIC GLASS

(71) Applicants: Won-Bae Lee, Seoul (KR); Ki-Bum Park, Bucheon-si (KR); Seong-Yong Park, Incheon-si (KR); Jung-Woong Lee, Anyang-si (KR); Sang-Gil Do, Suwon-si (KR); In-Bum Jeong, Bucheon-si (KR)

(72) Inventors: Won-Bae Lee, Seoul (KR); Ki-Bum Park, Bucheon-si (KR); Seong-Yong Park, Incheon-si (KR); Jung-Woong Lee, Anyang-si (KR); Sang-Gil Do, Suwon-si (KR); In-Bum Jeong, Bucheon-si (KR)

(73) Assignee: CHANG SUNG CO., Incheon-si (KR)

(21) Appl. No.: 13/823,295

(22) PCT Filed: Sep. 8, 2011
(86) PCT No.: PCT/KR2011/006662

§ 371 Date: Mar. 14, 2013

(30) Foreign Application Priority Data
Sep. 14, 2010 (KR) 10-2010-00089974

(51) Int. Cl. H05B 3/00

(52) U.S. Cl. CPC H05B 3/0004
USPC 219/552

(57) ABSTRACT

The present invention relates to a plane heating element which is supplied with power to generate heat. The plane heating element may include a support layer made of ceramic glass, a heat-generating layer which is formed by printing heat-generating paste on the upper surface of the support layer, and an insulating layer which is formed by applying insulating paste on the upper surface of the heat-generating layer. The heat generating paste may be dried and plasticized, and receives predetermined power to generate heat. The insulating paste may be dried and plasticized and may be configured to insulate the and prevent oxidation of the heat-generating layer. The present invention provides a strong adhesion with respect to a glass substrate and makes it possible to increase temperature up to a target level in a short time, and thus can be used as an effective printing method in various electric and electronic product fields.

### CROSS-REFERENCE TO RELATED APPLICATION(S)

The present application claims the benefit of International Application No. PCT/KR2011/006662, filed on Sep. 8, 2011, which claims priority from Korean Patent Application No. 10-2010-0089974, filed on Sep. 14, 2010.

### BACKGROUND

1. Field

The following description relates to a plane heating element using ceramic glass, and more particularly, to a plane heating element which is formed by applying heat-generating paste, comprising Ag powder, Ag—Pd based powder, and a glass frit, to ceramic glass and coating glass frit on the resulting ceramic glass.

2. Description of the Related Art

A heater using a conventional plane heating element has a support layer, at the base of the structure, which is generally made of steel, quartz glass, or alumina.

However, a support layer made of steel may experience thermal deformation at temperatures over 300° C., therefore the steel support layer cannot be used as a heat plate, but instead used as a heater plate, which is usually in contact with water, so as to avoid thermal deformation.

In addition, a support layer made of alumina can be used at a high temperature over 300° C., but is sensitive to thermal impact and thus responds very slowly to a change in temperature, therefore it is not possible to use this layer for a part that requires a rapid increase in temperature.

Further, quartz glass, as high purity silica glass with minimum impurities, comprising almost 100% SiO₂, has excellent light transmittance, so it is used in various parts of devices where transparency does not cause an inconvenience, so as to implement, for example, a heater. However, if inconveniences are caused by the transparency of the heater, quartz glass is not used.

Unlike the substances described above, ceramic glass, represented by lithium aluminum silicate glass, has translucent properties, and is, thus, used in parts of a device where its transparency causes an inconvenience. For this reason, ceramic glass has been generally used as a top cover for Ni—Cr heaters, for the sake of the heater's design.

Existing heat-generating paste and insulating paste, used in a conventional support layer made of steel, quartz glass or alumina, cannot be applied to ceramic glass, represented by lithium alumina silicate glass, because cracking occurs after plasticization of the paste due to differences in the thermal expansion coefficient and the shrinkage rate. Therefore, development of heat-generating paste and insulating paste, suitable for ceramic glass, such as lithium aluminum silicate glass, and a plane heating element using the ceramic glass with these pastes, is urgently needed.

### SUMMARY

One objective, of the present invention, is to provide a plane heating element using ceramic glass which has excellent adhesion strength to a glass substrate, thus making it possible to increase temperature up to a target level in a short period of time, and therefore it can be used as an effective screen-printing method in various electric and electronic product fields.

In addition, another objective of the present invention is to provide a plane heating element which is made of ceramic glass, such as lithium aluminum silicate glass, heat-generating paste and an overglazer, and can be used in various parts of household goods and industrial heaters without inconvenience due to its transparency, in order to provide rapid increase in temperature.

According to an aspect of embodiment, there is provided a plane heating element using ceramic glass and being capable of generating heat when being supplied with power, the heating element comprising: a support layer made of the ceramic glass; a heat-generating layer being formed by printing heat-generating paste on an upper surface of the support layer, and then drying and plasticizing the heat-generating paste, and configured to receive predetermined power to generate heat, wherein the heat-generating paste comprises 10 to 50 weight % of Ag powder, 2 to 30 weight % of Ag—Pd-based powder, 10 to 25 weight % of glass frit, organic binder and a solvent; and an insulating layer formed by applying insulating paste to an upper surface of the heat-generating layer, and then drying and plasticizing the insulating paste in an effort to insulate the heat-generating layer and prevent oxidation of the heat-generating layer, wherein the insulating paste comprises 60 to 70 weight % of glass frit having glass transition temperature ranging between 370 and 500 C, organic binder and a solvent.

Accordingly, the plane heating element using ceramic glass may have excellent adhesion strength to a glass substrate, therefore making it possible to increase the temperature up to a target level in a short period of time, and then it can be used as an effective screen-printing method in various electric and electronic product fields.

In addition, the plane heating element formed by ceramic glass, such as lithium aluminum silicate glass, the heat-generating paste and an overglazer, can be used in various parts of household goods and industrial heaters without causing inconvenience due to transparency, in order to provide rapid increase in temperature.

Other features and aspects may be apparent from the following detailed description, the drawings, and the claims.

### BRIEF DESCRIPTION OF THE DRAWINGS

FIG. 1 is a top view of a plane heating element using ceramic glass according to an exemplary embodiment of the present invention.

FIG. 2 is a cross-sectional view of the plane heating element shown in FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, a configuration and operation of a plane heating element using ceramic glass according to an exemplary embodiment of the present invention will be described in detail with reference to the accompanying drawings.

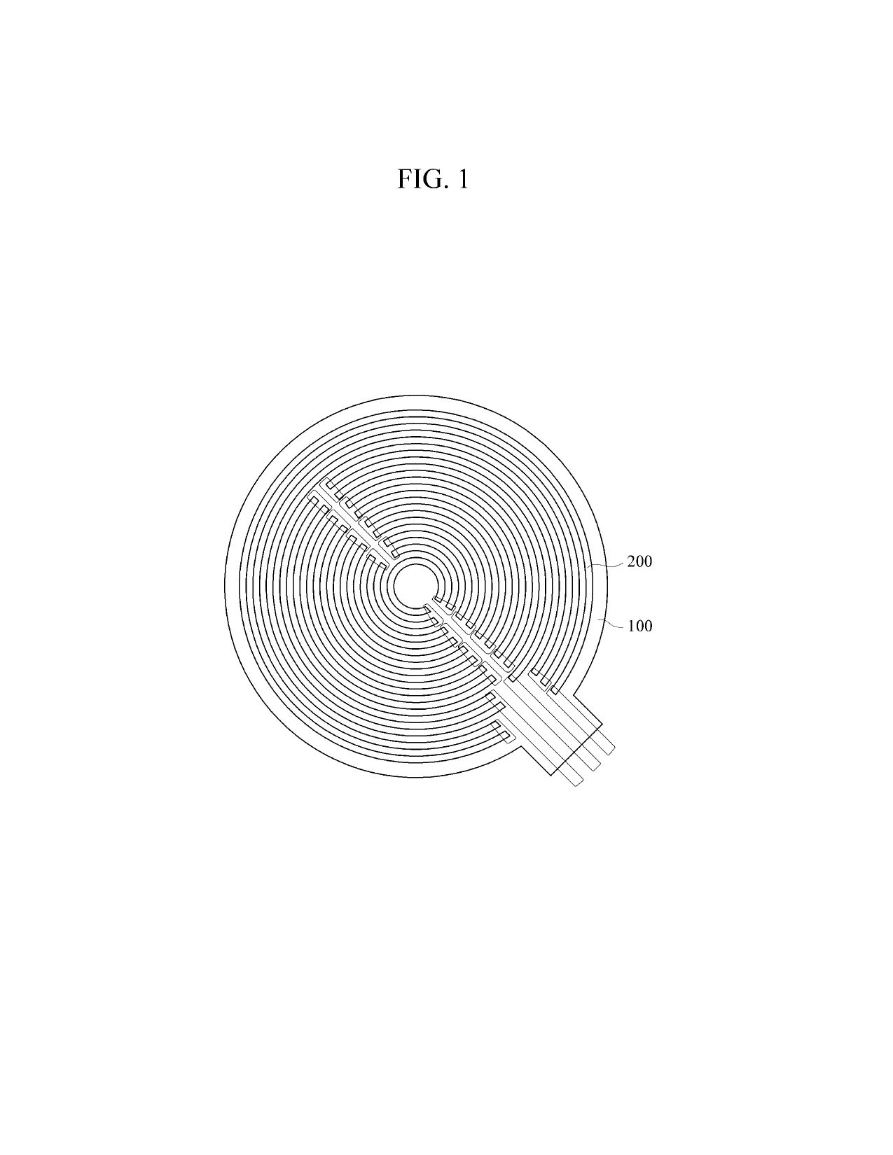

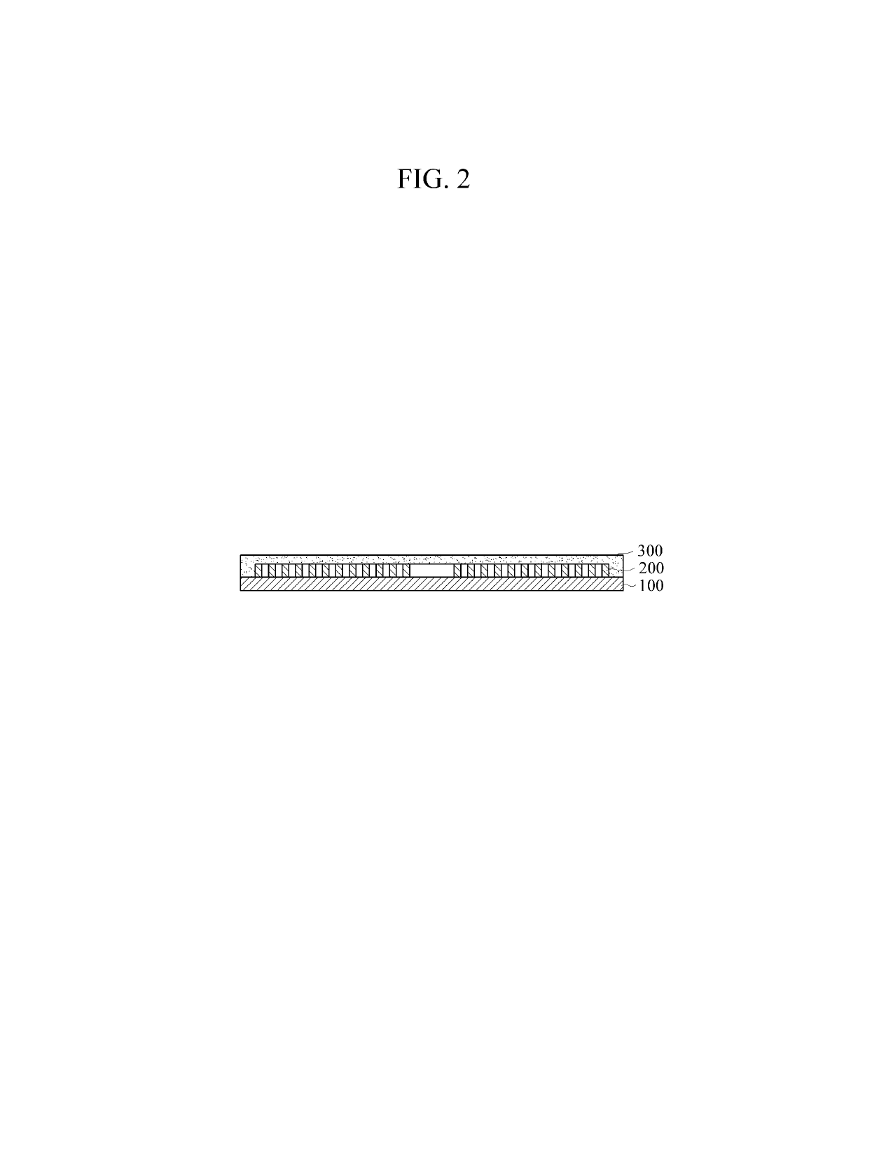

FIG. 1 is a top view of a plane heating element using ceramic glass according to an exemplary embodiment, and FIG. 2 is a cross-sectional view of the plane heating element shown in FIG. 1.

The embodiment described herein relates to the plane heating element generating heat when receiving power, and provides the plane heating element using ceramic glass. The plane heating element includes a support layer 100 made of ceramic glass, a heat-generating layer 200 which is formed by printing heat-generating paste on an upper surface of the support layer 100 and then drying and plasticizing the heat-generating paste, and which generates heat when receiving predetermined power, wherein the heat-generating paste comprises 10 to 50 weight % of Ag powder, 2 to 30 weight % of Ag—Pd-based powder, 10 to 25 weight % of glass frit, an organic binder and a solvent, and an insulating layer 300 which is formed by applying insulating paste to an upper surface of the heat-generating surface and then drying and plasticizing the insulating paste in an effort to insulate the heat-generating layer 200 and prevent oxidation of the heat-generating layer 200.

The support layer 100 is made of ceramic glass.

The heat-generating layer 200 is supplied with predetermined power to generate heat, which is formed by printing heat-generating paste on the upper surface of the support layer 100 and then drying and plasticizing the heat-generating paste, wherein the heat-generating paste comprises 10 to 50 weight % of Ag powder, 2 to 30 weight % of Ag—Pd-based powder, 10 to 25 weight % of the glass frit, the organic binder and the solvent.

The Ag powder and Ag—Pd-based powder contained in the heat-generating paste have effects on both electrical properties and the resulting mechanical characteristics of the plane heating element. The glass frit controls an inorganic binder and resistance properties. The glass frit contained in the insulating paste protects an electrode and insulates the electrode from other elements. The organic binders contained in each paste are used to mix and disperse conductive materials and the glass frit, and have effects on the fluidity of paste in the process of screen painting.

The organic binder may be thermoplastic and thermosetting. Examples of a thermoplastic binder may include an acrylic binder, an ethyl cellulous binder, a polyester binder, a polysulfone binder, a polyamide-based binder, and the like. Examples of a thermosetting binder may include an amino binder, an epoxy binder, a phenol binder, and the like. In addition, the organic binder may be used solely or in combination with other types of organic binders.

In particular, the organic binder may desirably be thermoplastic resin which has a small amount of organic binder residues or decomposition products after heat-processing.

The solvent may be chosen depending on the type of organic binder. As the solvent, aromatic hydrocarbons, ethers, ketones, lactones, ether alcohols, esters, or di-esters may be used solely or in combination with other types of solvents.

The mixing ratio of the heat-generating paste is given in the reasons described below.

Less than 10 weight % of Ag powder causes an increase in resistance, and greater than 50 weight % of Ag powder generates heat at 270° C. or higher, resulting in deterioration of resistance properties.

In addition, less than 2 weight % of Ag—Pd-based powder causes an increase in resistance change ratio in the printing process, which makes it difficult to maintain a constant temperature, and greater than 30 weight % of Ag—Pd-based powder generates heat at 300° C. or higher, which may damage an electrode.

Adhesiveness decreases when the amount of the glass frit is less than 10 weight %, and when the amount of the glass frit is greater than 25 weight %, electrical conductivity increases, thereby causing a thermal problem.

Thus, the heat-generating paste is made by mixing 10 to 50 weight % of Ag powder, 2 to 30 weight % of Ag—Pd-based powder, 10 to 25 weight % of glass frit, the organic binder, and the solvent.

The insulating layer 300 is formed by applying insulating paste to an upper surface of the heat-generating layer 200, and drying and plasticizing the insulating paste in an effort to insulate the heat-generating layer 200 and prevent oxidation, wherein the insulating paste comprises from 60 to 70 weight % of a glass frit having glass transition temperature ranging between 370 and 500° C., an organic binder and a solvent.

Additives contained in the paste composition may include an inhibitor and an antioxidant to improve storage stability of the paste composition, an antifoamer to remove foam from the composition, a dispersant to improve paste dispersibility, and a leveling agent to improve evenness of an electrode film during print coating process. The additives do not necessarily always have to be used, but it is used depending on characteristics of the paste, and at the time of use, it may be desirable to use only the minimum amount of additives.

In one example, the Ag powder contained in the heat-generating paste has an average particle size ranging between 0.1 and 6 μm, and Ag—Pd-based powder has an average particle size ranging between 0.5 and 2 μm.

Particles of the Ag powder, serving as conductive powder, may vary in shape, such as a sphere and a flake, or may be amorphous. The average particle size of the Ag powder may generally range between 0.1 and 30 μm, and desirably, but not necessarily, between 0.1 and 2 μm, so as to provide excellent surface roughness properties after the printing or coating process, as well as conductivity to a resulting electrode. If the average particle size exceeds 6.0 μm, sintering properties are deteriorated, thereby reducing density of a coating layer and thus resulting in an increase in resistance. If the average particle size is less than 0.1 μm, shrinkage increases during sintering and the thermal expansion coefficient difference between the powder and the glass substrate becomes greater, which may cause an internal crack, and thus it is not possible to implement uniform resistance properties.

In addition, the Ag—Pd-based powder, used for resistance stabilization, has an average particle size ranging between 1 and 10 μm, and more desirably, but not necessarily, ranging between 0.5 and 2 μm. If the average particle size is greater than 2 μm, surface roughness of the paste coating layer increases and characteristics of the printing line are deteriorated. Accordingly, it becomes difficult to achieve uniform screen printing.

In one example, the glass frit contains, in oxide conversion, 35 to 80 weight % of bismuth (III) oxide (Bi₂O₃), 5 to 20 weight % of boron trioxide (B₂O₃), 2 to 30 weight % of zinc oxide (ZnO), and 3 to 10 weight % of aluminum oxide (Al₂O₃).

If the amount of bismuth(III) oxide (Bi₂O₃), serving as a glass-forming agent, is less than 35 weight %, the glass softening point rises, which may cause a problem in adhesiveness, and if the amount is greater than 80 weight %, electrode cracking may occur due to an increase in thermal expansion coefficient.

In addition, if the amount of boron trioxide (B₂O₃), serving as a glass-forming agent, is less than 5 weight %, glass formation is impossible, and if the amount exceeds 20 weight %, electrical properties of the resulting electrode may be deteriorated.

SiO₂, which is a glass network forming oxide, has a structure in which a Si atom is surrounded by four oxygen atoms and is bonded to four neighboring Si atoms while sharing the surrounding oxygen atoms. A key factor to determine a glass transition temperature and durability is the amount of SiO₂. If the amount of SiO₂ is less than 5 weight %, the durability is reduced, and if the amount of SiO₂ exceeds 20 weight %, it may bring about non-plasticity.

ZnO, as a glass modifier, chemically stabilizes glass, and decreases the glass transition point and thermal expansion coefficient. The amount of ZnO may be desirably, but not necessarily, in a range between 2 to 30 weight % because if the amount of ZnO exceeds 30 weight %, a resulting electrode may be discolored in the process of plasticization.

Al₂O₃ stabilizes glass in the composition described above. Containing too much Al₂O₃ may increase the glass transition point and the softening point, whereas too small an amount may cause the glass stability to be deteriorated and thereby result in crystallization.

In one example, the heat-generating paste printed on the upper surface of the support layer 100 is dried at a temperature between 130 and 150° C. and is plasticized at a temperature between 700 and 850° C., and the insulating paste applied onto the upper surface of the heat-generating layer 200 is plasticized at a temperature between 370 and 500° C.

Since the plasticization temperature of the heat-generating paste is greater than the plasticization temperature of the insulating paste, there is no damage to the electrode of the heating element. In a reversed situation where the plasticization temperature of the insulting paste is higher than that of the heat-generating paste, electrode cracking may occur due to differences in the thermal expansion coefficient and the shrinkage rate between the heat-generating paste and the insulating paste.

If the plasticization temperature of the heat-generating paste is lower than 700° C., the electrode may be damaged by the adhesive force and the high resistive heat temperature. However, if the plasticization temperature is greater than 850° C., electrode heating may not occur due to over-sintering.

Further, the glass frit used for the over-glaze paste serves to protect the heat-generating paste and to insulate the electrode from external components.

The transition point of the glass frit ranges between 370 and 500° C., and more desirably, but not necessarily, between 400 and 470° C. If the transition point is lower than 370° C., the thermal expansion coefficient of the glass frit increases, which may cause a difference in stress between the glass frit and the substrate so that cracking occurs and adhesiveness is reduced. However, when the transition point is greater than 500° C., the fluidity of the glass frit decreases, and therefore the adhesion strength to the substrate is reduced.

In one example, the support layer 100 is made of lithium-aluminum silicate glass.

Existing plane heating elements may use a substrate which is made of steel, quartz glass, alumina and the like, whereas the plane heating element described herein uses ceramic glass (mixed composition, such as SiO₂, Al₂O₃, LiO₂, TiO₂, and the like) which is represented by lithium aluminum silicate glass that is suitable to the design and characteristics of a high-temperature heater.

In conventional heating elements, a steel plate cannot be used as a supporting hot plate since thermal deformation may occur when it is used at a high temperature over 300° C., and for this reason, it is used as a heater plate that is usually in contact with water, so that the thermal deformation may be prevented.

In addition, alumina can be used at a high temperature over 300° C., but is sensitive to thermal impact and responds very slowly to a change in temperature, therefore it is not possible to use alumina as a part that requires rapid temperature increase. Quartz glass, as high purity silica glass with minimum impurities, comprising almost 100% SiO₂, has excellent light transmittance, so that it is used in various parts of devices where transparency does not cause inconvenience, so as to implement, for example, a heater. However, if inconveniences are caused by the transparency of the heater, quartz glass is not used.

A surface of the quartz glass should be silk-printed or painted in an effort to add color to the quartz glass, and in this case, the quartz glass becomes opaque and the color may not be satisfactorily represented. In addition, since a paint for coloring is burnt during the plasticizing process of a plane heating element (around 850° C.), problems may occur in the further printing or painting process. Hence, the surface of the heater, on which the plane heating element is printed, cannot be colored, and therefore the coloring is inevitably processed on the opposite surface, which is, however, a place where cookware is located and is easily scratched by the cookware and cooking utensils, so problems may be caused in terms of the design and the quality of the heater.

Moreover, quartz glass is too expensive to use for a substrate of general household goods. Generally, a quartz glass plane heating element has been used without applying an insulating coating layer for protection of the heating element since it has been used as an unexposed part.

Unlike the substances described above, ceramic glass, represented by lithium aluminum silicate glass, has translucent properties, and thus can be used in parts of a device where its transparency causes inconvenience. For this reason, ceramic glass has been generally used as a top cover of, for example, a Ni—Cr heater, for the sake of the heater's design. In addition, since the ceramic glass is made from a composition mixture of various types of materials, it is cheaper than quartz glass. The thermal properties of ceramic glass, as a compound made from various materials, are different from those of quartz glass consisting of almost 100% SiO₂. The lithium aluminum silicate is a more suitable material for a substrate of a plane heating element since heat conductivity is 1.7 W/mk, which is 20% greater than the heat conductivity of quartz glass that is 1.4 W/mk. The lithium aluminum silicate glass as ceramic glass, however, has never been used as a substrate of a plane heating element. Ceramic glass of lithium aluminum silicate glass cannot be applied to a plane heating element, using the existing quartz glass, because a thermal expansion rate (0.4 um/mk) of the quartz glass is different from a thermal expansion rate (1 um/mk) of the lithium aluminum silicate glass. The plane heating element described herein is implemented to be suitable for synthetic ceramic glass, such as lithium aluminum silicate glass. In addition, the insulating layer described herein has been developed by taking into consideration the characteristics of lithium aluminum silicate glass and the plane heating element, so as to protect the heating element after the heating element is printed and plasticized on a substrate made of lithium aluminum silicate glass.

Embodiments of the plane heating element will now be provided for detailed description thereof.

### Embodiment 1

Electrode paste for ceramic glass heat was obtained by mixing components of the composition described above. First, an organic binder and a solvent were added to a mixer, the resulting mixture was well mixed by agitation, and thereby a vehicle was generated. Thereafter, metal powder, an inorganic binder, additives and the vehicle were added to a planetary mixer, and the added components were mixed and agitated. Resulting mixed paste was mechanically mixed using a 3-roll mill. Then, particles having large grain sizes and impurities, such as dust, were filtered out, and the defoamation process was performed to the filtered paste by use of a defoamer device in order to get rid of bubbles from the paste. As a result, a conductive paste composition using Ag-coated glass powder was fabricated.

TABLE 1

| | | Comparative | Comparative |
|---|---|---|---|
| | Embodiment 1 | Example 1 | Example 2 |
| Ag parts by weight | 40 | 55 | 40 |
| Ag/Pd parts by weight | 15 | 20 | 30 |
| Glass frit Tg | 10 | 10 | 10 |
| (inorganic binder) | | | |
| Pattern resistance | 60Ω | 10Ω | 120Ω |
| Time to heat up to | 30 sec | 5 min | X |
| 300° C. | | | |

Ethyl cellulous of 5 parts by weight was added and a coating layer was formed by a screen printing scheme. The coating layer was dried at 150° C. for 10 minutes, and then maintained at 850° C. for 10 minutes for plasticization.

As shown in Table 1, it took 30 seconds until the surface of the resistance, coated with the heat-generating paste obtained in Embodiment 1, was heated up to 300° C. In comparative examples 1 and 2, resistance properties were degraded depending on the content of Ag powder and Ag/Pd powder, and accordingly the target temperature and the target heating time were not achieved.

Thermal properties may be taken into consideration in designing a pattern of a heater which is formed by applying the paste composition, described above to lithium aluminum silicate glass, as ceramic glass. In embodiment 2, described hereinafter, a heater with the technical factors described above applied thereto had heating patterns which had regular widths and were spaced at regular intervals.

### Embodiment 2

TABLE 2

| | | Comparative | Comparative |
|---|---|---|---|
| | Embodiment 2 | Example 3 | Example 4 |
| B2O3 | 10 | 5 | 20 |
| Zn0 | 13 | 10 | 14 |
| SiO2 | 7 | 3 | 20 |
| Al2O3 | 3 | 2 | 13 |
| Bi2O3 | 67 | 80 | 33 |
| SUM | 100 | 100 | 100 |
| Tg(° C.) | 420 | 302 | 498 |
| Pencil hardness | >9H | >9H | <3H |
| Resistivity variation | 0% | +20% | 0% |

After a heating element electrode was plasticized, the surface of the electrode was coated with overglaze paste which had been obtained through the procedures described above, and the electrode coated with the paste was dried at 150° C. for 10 minutes and then plasticized at 500° C. for 30 minutes.

As shown in Table 2, the paste obtained from embodiment 2 exhibited glass frit with Tg of 420° C., pencil hardness of 9H and 0% of resistivity variation, whereas the glass frit in comparative examples 3 and 4 showed results in which pencil hardness and/or resistivity variation decreased after plasticization, and thus it was not possible to use the pastes as over-graze paste.

As described above, the plane heating element using ceramic glass, according to the exemplary embodiment of the present invention, has excellent adhesion strength to the glass substrate, and makes it possible to increase a temperature up to a target level in a short period of time, therefore it can be used as an effective screen-printing method in various electric and electronic product fields, also the plane heating element formed by ceramic glass, such as lithium aluminum silicate glass, the heat-generating paste as well as an overglazer, can be used in various parts of household goods and industrial heaters without inconvenience due to transparency, in order to provide rapid increase in temperature.

A number of examples have been described above. Nevertheless, it should be understood that various modifications may be made. For example, suitable results may be achieved if the techniques described are performed in a different order and/or if components in a described system, architecture, device, or circuit are combined in a different manner and/or replaced or supplemented by other components or their equivalents. Accordingly, other implementations are within the scope of the following claims.

What is claimed is:

1. A plane heating element using ceramic glass which is capable of generating heat when receiving power, the heating element comprising:
a support layer made of the ceramic glass;
a heat-generating layer formed by printing heat-generating paste on an upper surface of the support layer, and then drying and plasticizing the heat-generating paste, and configured to receive predetermined power to generate heat, wherein the heat-generating paste comprises 10 to 50 weight % of Ag powder, 2 to 30 weight % of Ag—Pd-based powder, 10 to 25 weight % of glass frit, an organic binder and a solvent; and
an insulating layer formed by applying insulating paste to an upper surface of the heat-generating layer, and drying and plasticizing the insulating paste in an effort to insulate the heat-generating layer and prevent oxidation of the heat-generating layer, wherein the insulating paste comprises 60 to 70 weight % of glass frit having glass transition temperature ranging between 370 and 500° C., organic binder and a solvent.

2. The plane heating element of claim 1, wherein the Ag powder contained in the heat-generating paste has an average particle size ranging between 0.1 and 6 μm, and the Ag—Pd-based powder has an average particle size ranging between 0.5 and 2 μm.

3. The plane heating element of claim 1, wherein the glass frit contains, in oxide conversion, 35 to 80 weight % of bismuth(III) oxide (Bi₂O₃), 5 to 20 weight % of boron trioxide (B₂O₃), 2 to 30 weight % of zinc oxide (ZnO), and 3 to 10 weight % of aluminum oxide (Al₂O₃).

4. The plane heating element of claim 1, wherein the heat-generating paste is dried at a temperature between 130 and 150° C., and is plasticized at a temperature between 700 to 850° C., and the insulating paste applied onto the upper surface of the heat-generating layer is plasticized at a temperature between 370 and 500° C.

5. The plane heating element of claim 1, wherein the support layer is made of lithium-aluminum silicate glass.
